(19) United States
(12) Patent Application Publication
(10) Pub. No.: US 2026/0017402 A1
(43) Pub. Date: Jan. 15, 2026

(54) TENANT SOVEREIGNTY ZONE

(71) Applicant: comforte AG, Wiesbaden (DE)

(72) Inventors: Michael HORST, Wuthenow (DE); Robert MOL, Omaha, NE (US)

(73) Assignee: comforte AG, Wiesbaden (DE)

(21) Appl. No.: 18/769,145

(22) Filed: Jul. 10, 2024

(51) Int. Cl. G06F 21/62; G06F 21/60

(52) U.S. Cl. CPC G06F 21/6245; G06F 21/606

(57) ABSTRACT

A system for secure processing and storing of sensitive data and non-sensitive data for a tenant in an execution environment of a Software as a Service provider or a Platform as a Service provider is disclosed. In the present disclosure, the sensitive data includes a plaintext sensitive data element. The non-sensitive data does not include a plaintext sensitive data element. The execution environment of the system comprises a general execution area. The general execution area allows full access by the Software or the Platform as a Service provider, and a general application service running in the general execution area, wherein the general application service does not have access to the sensitive data, and wherein the general application service only processes the non-sensitive data. Furthermore, the execution environment of the system comprises a trusted execution area, and a trusted application service running in the trusted execution area.

### BACKGROUND

### (1) Technical Field

The present disclosure relates to a system for secure processing and storing of sensitive data and non-sensitive data of a tenant in an execution environment of a Software as a Service provider or in an execution environment of a Platform as a Service provider.

### (2) Technical Field

Software as a Service (SaaS) and Platform as a Service (PaaS) solutions offer an economic and efficient way for a software user to access a particular software without a requirement to install and operate the software at the users own computer or server. The service provider provides the software in a data center, operates it and provides technical support and advice to the users. The service provider typically takes over all the necessary components of a data center: Networks, data storage, databases, application services, web services as well as disaster recovery and data backup services. In addition, other operational services such as authentication, availability, identity management, production control, patch management, activity monitoring, software upgrades and customization are carried out by the service provider. The user or service recipient does not install purpose-built software. Only an Internet-enabled computer and an Internet connection to the service provider are required for use. Access to the software is typically implemented via a versatile web browser.

Typical applications of SaaS are business software, e.g. an ERP system, or editorial software, e.g. an editorial system for technical documentation. PaaS is a service that provides a computer platform in the cloud for developers of web applications. These can be both quickly deployable run time environments (typically for web applications) and development environments that can be used with little administrative effort and without the need to purchase the underlying hardware and software. PaaS supports the entire software lifecycle from design to development, testing, delivery and operation of applications via the Internet.

It has turned out that a substantial amount of new business is currently not attainable by SaaS and PaaS providers due to the constraint requiring that the customers also give up their exclusive control of their regulated data and of their private data. Regulated data are subject to statutory provisions and private data are subject to the company's internal regulations.

Consequently, there is a need for a system for secure processing and storing of sensitive data and non-sensitive data in execution environments of a Software as a Service provider or a Platform as a Service provider.

### SUMMARY

At least one of the above objects is solved by a system for secure processing and storing of sensitive data and non-sensitive data for a tenant in an execution environment of a Software as a Service provider or a Platform as a Service provider according to the attached independent claim 1. In the system according to the present disclosure, the sensitive data includes a plaintext sensitive data element. In contrast, the non-sensitive data does not include a plaintext sensitive data element. The execution environment of the system comprises a general execution area, wherein the general execution area allows full access by the Software as a Service provider or the Platform as a Service provider, and a general application service running in the general execution area, wherein the general application service does not have access to the sensitive data, and wherein the general application service only processes the non-sensitive data. Furthermore, the execution environment of the system comprises a trusted execution area, and a trusted application service running in the trusted execution area.

In the following text, the term “Software as a Service” will be used generically to cover also a Platform as a Service. The term “Software as a Service provider” will be used generically to cover also a Platform as a Service provider. The short forms are used only in order to abbreviate the text and to enhance readability.

A tenant, in the sense of the present application, is a user entity of the Software as a Service application and thus a customer of the Software as a Service provider. The tenant in turn may have one or a plurality of users.

According to present disclosure there may only be a single trusted application service running in the trusted execution area. However, in an embodiment a plurality of trusted application services is running in the trusted application area. According to present disclosure there may only be a single general application service running in the general execution area. However, in an embodiment a plurality of general application services is running in the general application area.

While the system might be used for a single tenant in most real-world applications, the system enables secure processing and storing sensitive data and non-sensitive data for a plurality of tenants.

While the system is described before and in the following with a single execution environment, it may have a plurality of execution environments. The execution environment is also described with a single trusted execution area for each tenant. However, in an embodiment, the execution environment for each tenant comprises a plurality of trusted execution areas.

Typically, a Software as a Service architecture consists of a control or management plane and an application or data plane. The idea of the present disclosure is to split up the conventional application/data plane into an identified data plane, i.e. a data plane operating on identifiable sensitive data, and a de-identified data plane, i.e. a data plane operating on de-identified non-sensitive data. The identified data plane is deployed in a per-tenant trusted and preferably isolated execution area also referred to as the “tenant sovereignty zone”. The de-identified data plane is characterized by the general application service having no access to the plaintext sensitive data element.

It is the general concept of the present disclosure to provide a system for secure processing and storing sensitive data and non-sensitive data of a tenant by a Software as a Service provider which splits the execution environment under control of the Software as a Service provider into a general execution area and a trusted execution area. The trusted application running in the trusted execution area is the only service in the execution environment having access to the sensitive data. In the trusted execution area, a tenant retains exclusive control of their regulated data and private data satisfying data sovereignty, residency and privacy requirements as well as internal policies for sensitive data. The Software as a Service provider cannot access these regulated or private data from the general execution area. At the same time, the execution environment is part of the Software as a Service provider's execution environment, deployed and operated by the Software as a Service provider.

By providing the execution environment of a Software as a Service provider with the trusted execution area according to the present disclosure, the service provider can demonstrate compliance to their customers and to external auditors more easily reducing compliance costs. Furthermore, the risk of a breach of the exfiltration of regulated or private customer data is reduced, since the service provider by a matter of the systematic of the architecture of the system does not have access to the regulated data.

The system according to the present disclosure relies on the system's ability to distinguish between sensitive data and non-sensitive data. In an embodiment an insolation of the trusted application service or the plurality of trusted application services running in the trusted execution area against access by the general application service or the plurality of general application services running in the general execution area is implemented.

Consequently, in an embodiment of the present disclosure, the system provides a routing functionality identifying sensitive data on the one hand and non-sensitive data on the other hand. The sensitive data is always routed to the trusted application services or to one of the plurality of trusted application services, wherein the non-sensitive data can directly be routed to the general application service or to one of the plurality of general application services if applicable.

In an embodiment, the routing functionality is carried out by a gateway service.

In an embodiment of the present disclosure, the trusted application service is a gateway service, wherein the gateway service is configured in such a way that during operation of the system the gateway service splits the sensitive data and the non-sensitive data, always routes the sensitive data to the trusted execution area, and optionally routes the non-sensitive data to the general execution area. This way, processing of sensitive data only in the trusted execution area is guaranteed.

The routing functionality implemented in the gateway becomes more sophisticated if for any reason the sensitive data comprising at least one plaintext data element needs processing by the general application service for further use in the general execution area. In this case the plaintext sensitive data element must not be transmitted as plaintext and the sensitive data must be converted into non-sensitive data before transmission to the general execution environment.

In an embodiment of the present disclosure, conversion of the sensitive data into non-sensitive data before transmission to the general execution environment is carried out by the gateway service. In a further embodiment of the present disclosure, the gateway service performs replacement of any plaintext sensitive data element by a placeholder in order to transform the sensitive data into non-sensitive data which can be transferred or routed to the general execution area, in particular to one or more of the general application services running in the general execution area.

In a further embodiment of the present disclosure, the system comprises a plurality of trusted application services running in the trusted execution area, wherein one of the plurality of trusted application services is a replacement service. The replacement service is configured in such a way that during operation of the system the replacement service carries out a number of steps in two phases, namely in a securing phase and in a retrieval phase. In the securing phase, the replacement service carries out the steps: Receiving the plaintext sensitive data element from a requesting service originating from the plurality of trusted services, providing a placeholder for the at least one plaintext sensitive data element in a way allowing later reconstitution of the sensitive data element from the placeholder, and sending the placeholder to the requesting service. During the retrieval phase, the replacement service carries out the steps: Receiving the placeholder from a requesting service originating from the plurality of trusted services, the replacement service reconstituting the plaintext sensitive data element associated with the placeholder, and the replacement service sending the plaintext sensitive data element to the requesting service.

In an embodiment of the present disclosure, the replacement service for providing a placeholder for the plaintext sensitive data element uses a method selected of a group consisting of pseudonymization, tokenization, anonymization, and encryption or a combination thereof.

In an embodiment of the present disclosure, the replacement service uses homomorphic encryption for providing a placeholder for the plaintext sensitive data element. A homomorphic encryption retains the ability to perform operations on a data set including the placeholder in a general execution service in the general execution area.

In an embodiment, the gateway service as well as the replacement service each are one of a plurality of trusted application services running in the trusted execution area. In the trusted execution area, all data, in particular plaintext sensitive data elements, are under full control of the tenant and cannot be accessed by the general application services. In this embodiment the routing functionality described above is carried out by the gateway service intercepting data traffic between the tenant and the execution environment, but the actual generation of the placeholder is sourced out to the replacement service. The gateway service interacts with the replacement service and uses services implemented in the replacement service.

Thus, in an embodiment of the present disclosure, the gateway service is configured in such a way that during operation of the system the gateway service carries out the following steps in a securing phase:
receiving the sensitive data including the plaintext sensitive data element from a tenant data source at the tenant outside the execution environment or from a trusted application service,
identifying the plaintext sensitive data element in the sensitive data, transmitting the plaintext sensitive data element to the replacement service,
receiving the placeholder from the replacement service,
replacing the sensitive data element in the sensitive data with the placeholder to generate the non-sensitive data, and
forwarding the non-sensitive data to the general application service.

In a retrieval phase, the gateway service of this embodiment carries out the following steps:
receiving the non-sensitive data including the placeholder from the general application service,
identifying the placeholder in the non-sensitive data,
transmitting the placeholder to the replacement service,
receiving the plaintext sensitive data element from the replacement service,
replacing the placeholder with the plaintext sensitive data element in the non-sensitive data to obtain the sensitive data, and
forwarding the sensitive data to a tenant data source at the tenant outside the execution environment or to a trusted service.

In many situations, it will be sufficient once the plaintext sensitive data element is replaced by a placeholder and then further routed to the general execution area. However, in an embodiment, the general application service or one of the plurality of general application services may need a processing executed on the non-sensitive data, wherein this processing requires an operation which can only be applied to the plaintext sensitive data element. In this embodiment, the general application service would send an instructing message to the trusted application service in the trusted execution area for carrying out this operation on the sensitive data.

Thus, in an embodiment of the present disclosure the trusted application service or one of the plurality of trusted application services is a trusted processing service. This trusted processing service receives an instructing message including a placeholder from the general application service. In order to be able to apply an operation on the sensitive data including the plaintext sensitive data element, this trusted processing service in an embodiment calls the replacement service to replace the placeholder by the plaintext sensitive data element.

In an embodiment of the present disclosure, a trusted processing service is the requesting service out of the plurality of trusted application services, wherein the trusted processing service is configured in such a way that during operation of the system the trusted processing service carries out the steps:
receiving a non-sensitive instructing message from the general application service,
identifying a placeholder in the instructing message,
transmitting the placeholder to the replacement service,
receiving the plaintext sensitive data element from the replacement service,
replacing the placeholder in the instructing message with the plaintext sensitive data element to obtain a non-sensitive instructing message,
processing the sensitive instructing message including the plaintext sensitive data element to obtain a sensitive data processing result,
identifying the plaintext sensitive data element in the sensitive data processing result,
transmitting the plaintext sensitive data element to the replacement service,
receiving the placeholder from the replacement service,
replacing the plaintext sensitive data element in the sensitive data processing result with the placeholder to generate a non-sensitive data processing result, and
transmitting the non-sensitive data processing result to the general application service.

In an alternative embodiment, wherein the general application service needs execution of an operation on a plaintext sensitive data element the general application service could send the instructing message to the gateway service as defined above and the gateway service in turn addresses the replacement service and after replacement sends the instructing message including the plaintext sensitive data element to a trusted application service.

In a further alternative embodiment, the trusted processing service could carry out the replacement in the trusted processing service without the necessity to call the replacement service or any other service.

In an embodiment of the present disclosure, the trusted execution area is isolated against access to the sensitive data and optionally to the non-sensitive data from the general application service or from a plurality of general application services in the general execution area and preferably by any service running under the control of the Software as a Service provider outside the trusted execution area.

In a further embodiment of the present disclosure, the trusted execution area is isolated such that the sensitive data in the trusted execution area is exclusively accessible by a service in the trusted execution area or by a service under the sole control of the tenant.

In an embodiment of the present disclosure, the system comprises a control plane for the execution environment enabling at least orchestration of the general application service in the general execution area and of the trusted application service in the trusted execution area by the Software as a Service provider. In a particular embodiment, the control plane enables orchestration of both, the general application service in the general execution area and the trusted application service in the trusted execution area by the Software as a Service provider.

The ability of orchestration and administration of the execution environment through a common control plane under the control of the Software as a Service provider maintains the advantages of Software as a Service while at the same time avoiding access of the sensitive data by the Software as a Service provider.

In order to allow orchestration by the Software as a Service provider the trusted execution area requires connectivity to the Software as a Service.

In an embodiment, in most scenarios the trusted execution area has access to the tenant's protection/encryption secrets.

In an embodiment of the present disclosure, the trusted execution area is implemented on premise or in a private or public cloud infrastructure under control of the tenant.

In a further embodiment of the present disclosure, the trusted execution area is isolated such that the sensitive data in the trusted execution area is exclusively accessible by the tenant by implementation of the trusted execution area in a hardware-based, attested trusted execution environment (TEE).

In a further embodiment of the present disclosure, the trusted execution area is implemented on an edge network. An edge network is a distributed computing paradigm that brings computation and data storage closer to the location where it is needed, rather than relying solely on centralized cloud servers. The term “edge” in this context refers to the outer or periphery of a network, closer to the endpoints or devices generating and consuming data. In an IOT solution it would be beneficial to de-identify the data as close to the source as possible. The sensitive data may be needed to interact with the devices but is not required for central management and data aggregation at the cloud application.
In an embodiment of the present disclosure, the trusted execution area is isolated from an edge network provider by performing computation in a hardware-based, attested trusted execution environment (TEE).

Particular embodiments of the present invention may comprise the sets of features listed in the following numbered statements 1 to 13.

### Statement 1

1. A system for secure processing and storing of sensitive data and non-sensitive data of a tenant in an execution environment of a Software as a Service provider or of a Platform as a Service provider;
wherein the sensitive data includes a plaintext sensitive data element;
wherein the non-sensitive data includes no plaintext sensitive data element;
wherein the execution environment comprises
   a general execution area,
      wherein the general execution area allows full access by the Software as a Service provider or the Platform as a Service provider, and
   a general application service running in the general execution area,
      wherein the general application service does not have access to the sensitive data, and
      wherein the general application service only processes the non-sensitive data; and
wherein the execution environment for the tenant comprises
   a trusted execution area, and
   a trusted application service running in the trusted execution area.

### Statement 2

2. The system according to the previous statement, wherein the trusted application service is a gateway service,
   wherein the gateway service is configured in such a way that during operation of the system the gateway service
      splits the sensitive data and the non-sensitive data,
      always routes the sensitive data to the trusted execution area, and
      optionally routes the non-sensitive data to the general execution area.

### Statement 3

3. The system according to any one of the previous statements, wherein the system comprises a plurality of trusted application services, wherein one of the plurality of trusted application service is a replacement service,
   wherein the replacement service is configured in such a way that during operation of the system the replacement service carries out the steps
   in a securing phase
      the replacement service receiving the plaintext sensitive data element from a requesting service originating from the plurality of trusted application services,
      the replacement service providing a placeholder for the at least one plaintext sensitive data element in a way allowing later reconstitution of the sensitive data element from the placeholder, and
      the replacement service sending the placeholder to the requesting service,
   and in a retrieval phase
      the replacement service receiving the placeholder from a requesting service originating from the plurality of trusted application services,
      the replacement service reconstituting the plaintext sensitive data element associated with the placeholder, and
      the replacement service sending the plaintext sensitive data element to the requesting service.

### Statement 4

4. The system according to the previous statement, wherein one of the plurality of trusted application services is a gateway service,
   wherein the gateway service is configured in such a way that during operation of the system the gateway service carries out the steps
   in a securing phase
      the gateway service receiving the sensitive data including the plaintext sensitive data element from a tenant data source at the tenant outside the execution environment or from one of the plurality of trusted application services,
      the gateway service identifying the plaintext sensitive data element in the sensitive data,
      the gateway service transmitting the plaintext sensitive data element to the replacement service,
      the gateway service receiving the placeholder from the replacement service,
      the gateway service replacing the sensitive data element in the sensitive data with the placeholder to generate the non-sensitive data, and
      the gateway service forwarding the non-sensitive data to one of the plurality of general application services,
   and in a retrieval phase
      the gateway service receiving the non-sensitive data including the placeholder from one of the plurality of general application services,
      the gateway service identifying the placeholder in the non-sensitive data,
      the gateway service transmitting the placeholder to the replacement service,
      the gateway service receiving the plaintext sensitive data element from the replacement service,
      the gateway service replacing the placeholder with the plaintext sensitive data element in the non-sensitive data to obtain the sensitive data, and
      the gateway service forwarding the sensitive data to a tenant data source at the tenant outside the execution environment or to one of the plurality of trusted application services.

### Statement 5

5. The system according to any one of the previous statements as far as dependent on statement 3, wherein a trusted processing service is the requesting service out of the plurality of trusted application services,
   wherein the trusted processing service is configured in such a way that during operation of the system the trusted processing service carries out the steps
      receiving a non-sensitive instructing message from the general application service,
      identifying a placeholder in the non-sensitive instructing message,
      transmitting the placeholder to the replacement service,
      receiving the plaintext sensitive data element from the replacement service,
      replacing the placeholder in the non-sensitive instructing message with the plaintext sensitive data element to obtain a sensitive instructing message,
      processing the sensitive instructing message including the plaintext sensitive data element to obtain a sensitive data processing result,
      identifying the plaintext sensitive data element in the sensitive data processing result,
      transmitting the plaintext sensitive data element to the replacement service,
      receiving the placeholder from the replacement service,
      replacing the plaintext sensitive data element in the sensitive data processing result with the placeholder to generate a non-sensitive data processing result, and
      transmitting the non-sensitive data processing result to the general application service.

### Statement 6

6. The system according to any one of the previous statements, wherein the trusted execution area is isolated such that the sensitive data in the trusted execution area is exclusively accessible by the tenant.

### Statement 7

7. The system according to any one of the previous statements, wherein the system comprises a control plane for the execution environment enabling at least orchestration of the general application service in the general execution area and of the trusted application service in the trusted execution area.

### Statement 8

8. The system according to any one of the previous statements, wherein the trusted execution area is implemented on premise or in a private or public cloud infrastructure under control of the tenant.

### Statement 9

9. The system according to any one of the previous statements, wherein the trusted execution area is isolated such that the sensitive data in the trusted execution area is exclusively accessible by the tenant by implementation of the trusted execution area in a hardware-based, attested trusted environment.

### Statement 10

10. The system according to any one of the previous statements, wherein the trusted execution area is implemented on an edge network.

### Statement 11

11. The system according to the previous statement, wherein the trusted execution area is isolated from an edge network provider by performing computation in a hardware-based, attested Trusted Execution Environment.

### Statement 12

12. The system according to any one of the previous statements, wherein for providing a placeholder for the plaintext sensitive data element the replacement service (16) uses a method of a group consisting of pseudonymization, tokenization, anonymization, and encryption.

### Statement 13

13. The system according to any one of the previous statements, wherein for providing a placeholder for the plaintext sensitive data element the replacement service uses homomorphic encryption.

### BRIEF DESCRIPTION OF THE DRAWINGS

Further advantages, features and applications of the present disclosure become apparent from the following description of embodiments and the corresponding figures attached. The foregoing as well as the following detailed description of the embodiments will be better understood when read in conjunction with the appended drawings. It should be understood that the embodiments depicted are not limited to the precise arrangements and instrumentalities shown. In the figures, like elements have been denoted by identical reference numbers.

FIG. 1 is a schematic representation of a system according to an embodiment of the present disclosure.

FIG. 2 is a schematic representation of a system according to a further embodiment of the present disclosure.

FIG. 3 is a schematic representation of an implementation of the system of FIG. 1 or 2.

FIG. 4 is a schematic representation of an alternative implementation of the system of FIG. 1 or 2.

FIG. 5 is a schematic representation of another implementation of the system of FIG. 1 or 2.

FIG. 6 is a schematic representation of yet another implementation of the system of FIG. 1 or 2.

FIG. 7 is a schematic representation of a system according to a yet another embodiment of the present disclosure.

### DETAILED DESCRIPTION

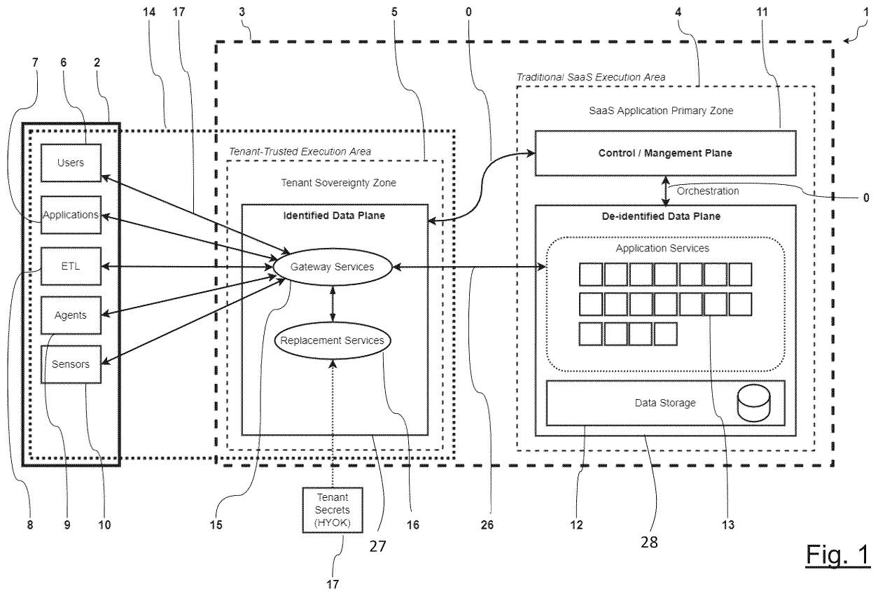

FIG. 1 proves an overview over a system 1 for secure processing and storing of sensitive data and non-sensitive data for a plurality of tenants according to the present disclosure. In the following paragraphs, operation of the system 1 is only described for a single tenant is in order to reduce complexity of the text. However, it is evident that the system 1 is particularly advantageous for a plurality of tenants.

The design of the system 1 enables handling of sensitive data for a tenant in an execution environment 3 of a Software as a Service provider. The tenant's sensitive data stems from tenant data sources 2. Typically, Software as a Service providers offer software services which are hosted, operated and managed by the Software as a Service provider. Those services can be used and accessed by the tenant using a simple Internet browser and thus without installing specific apps or services at the tenant's. While this is comfortable from an administration point of view and economically advantageous for the tenant, it may lead to conflicts with company rules of the tenant or even legal provisions once the software as a service shall process sensitive data underlying certain requirements with respect to privacy.

For the examples discussed here with reference to the Figures, it is assumed that the software as a service processes sensitive data, including bank account numbers. Each bank account number is considered a plane text sensitive data element in the sensitive data to be processed.

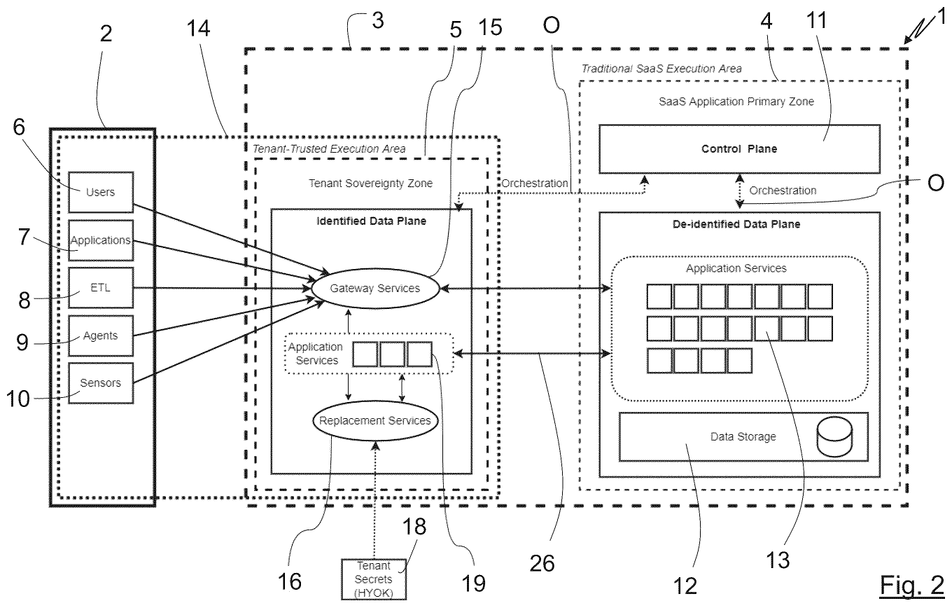

In order to address this particular problem, the system according to the present invention splits the Software as a Service provider's execution environment into a general execution area 4 and a plurality of trusted execution areas 5. The systems 1 of FIGS. 1 and 2 each have a trusted execution area 5 for each tenant. However, in the Figures only a single trusted execution area 5 is depicted.

The tenant typically runs a number of users 6, applications 7, ETL processes 8, agents 9 and sensors 10 denoted as the tenant data sources 2 in present application.

The general execution area 4 included in the Software as a Service provider's execution environment 3 provides the typical functionalities of an execution area as known from the prior art. The general execution area 4 has a control or management plane 11 which orchestrates O the general application area 4 including a data storage 12 and a plurality of general application services 13.

However, the control plane 11 also orchestrates O the trusted execution area 5 and more specifically the trusted application services 15, 16 operated in the trusted execution area 5. Although orchestrated and managed by the Software as a Service provider's control/management plane 11, the trusted execution area 5 does not allow any access by the general execution area 4 to any of the sensitive data processed in the trusted execution area 5.

The trusted execution area 5 is designed such that it is administratively part of the tenant's sovereignty sphere 14, and the sensitive data processed in the trusted execution area 5 cannot be accessed by the general execution area 4 of the Software as a Service provider. In fact, in the present example the sensitive data processed in the trusted execution area 5 cannot be accessed by any other entity but the tenant. In general, the trusted execution area 5 comprises at least one trusted application service running in the trusted execution area 5. In the example of FIG. 1, there are two trusted application services 15, 16 running in the trusted execution area 5.

The first trusted application service is a gateway service 15 and the second trusted application service is a replacement service 16. These two trusted application services 15, 16 of FIG. 1 only follow a single purpose, namely converting sensitive data including one or a plurality of plain text sensitive data elements into non-sensitive data which can be processed without any restrictions in the general execution area 4. In order to convert sensitive data into non-sensitive data, the plain text sensitive data element must be replaced by a de-identified or anonymous placeholder which does not allow any identification of a user or an entity when reading or processing the non-sensitive data including the placeholder. In the present example this means that the account number must be replaced by a format preserving placeholder. This replacement must be carried out such that the original plain text sensitive data element can be reconstituted from the respective placeholder.

The gateway service 15 of the system of FIG. 1 intercepts all data traffic 17 from the different entities 6, 7, 8, 9, 10 of the tenant data sources 2 into the Software as a Service provider's execution environment 3. The gateway service 15 in the data traffic 17 identifies the sensitive data including one or a plurality of plain text sensitive data elements and non-sensitive data. For the non-sensitive data, the gateway service 15 routes the respective data directly from the trusted execution area 5 into the general execution area 4. In the general execution area 4 the non-sensitive data is processed in one or more of the plurality of the general application services 13.

The gateway service 15 further identifies all plain text sensitive data elements in the data traffic 17. The respective sensitive data cannot be further routed to the general execution area 4. The plain text sensitive data elements under all circumstances must be kept under the tenant's sovereignty. Consequently, the gateway service 15 isolates the respective plain text sensitive data element and hands it on to the replacement service 16 requesting a placeholder in return.

The replacement service 16 receives the plain text sensitive data element from the gateway service requesting replacement and generates a placeholder for each of the plain text sensitive data elements. Finally, the replacement service 16 sends the placeholder to the gateway service 15. The gateway service 15 then includes the placeholder at the position of the initial plain text sensitive data element in the sensitive data. Through this exchange of the plain text sensitive data element by the placeholder in the gateway service 15, the initially sensitive data is converted into non-sensitive data. This non-sensitive data no longer includes the plain text sensitive data element, but a de-identified placeholder instead. This non-sensitive data including the placeholder is then routed for further processing to the general application area 4.

Replacement in the replacement service 16 according to the present example is based on homomorphic encryption of the plain text data element to generate the placeholder. Homomorphic encryption requires one or a plurality of tenant's secrets 18. These secrets 18 are under exclusive control of the tenant.

In the language of the present application, the operations of the replacement service 16 in order to provide the gateway service 15 with a placeholder associated with an initial plain text data element is denoted the securing phase.

Once after processing in any one of the general application services 13 in the general application area 4 data shall be returned to the tenant data sources 2, this data may contain placeholders which however will need exchange by the original plain text sensitive data element before representing useful information to the tenant 26. Consequently, all data traffic 26 from the general application services 13 to the tenant data sources 2 is intercepted by the gateway service 15 in the trusted execution area 5.

The gateway service 15 in the data traffic 26 detects sections which are placeholders. The respective identified placeholder is then sent to the replacement service 16. The replacement service 16 receives the placeholder from the gateway service as the requesting service, reconstitutes the initial plain text sensitive data element associated with the placeholder and returns the plain text sensitive data element to the gateway service. The gateway service 15 then exchanges the placeholder in the non-sensitive data by the original plain text sensitive data element. Finally, the gateway service 15 forwards the sensitive data to one or a plurality of the tenant's entities 6, 7, 8, 9, 10.

In the language of the present application, the operations of the replacement service 16 in order to provide the gateway service 15 with the initial plain text data element reconstituted from a placeholder is denoted the retrieval phase.

The embodiment of FIG. 2 contains all elements and functionalities described with reference to FIG. 1. Thus, the system 1 of FIG. 2 enables an operation of the combination of the gateway service 15 and the replacement service 16 as described with reference to the embodiment of FIG. 1. However, the system of FIG. 2 comprises additional trusted application services 19 in the trusted application area 5. These additional trusted application services 19 are so-called trusted processing services 19 as it is their purpose to process data on behalf of the general application services 13. The general application services 13 of the general application area 4 can only process non-sensitive data including data which has been converted into non-sensitive data by replacement of the initial sensitive data element by a placeholder.

However, applying operations to the non-sensitive data including the placeholder in most cases will not lead to correct results. Thus, in order to have the required operation still applied to the non-sensitive data including a placeholder, one of the general application services 13 sends a non-sensitive instructing message including the non-sensitive data comprising a placeholder to one of the trusted processing services 19.

The trusted processing services 19 receives the non-sensitive instructing message from the general application service 13 and identifies the placeholder in the sensitive instructing message. As the trusted processing service 19 itself according to this embodiment cannot carry out any replacements and reconstitutions, the trusted processing service 19 transmits the placeholder to the replacement service 16.

The replacement service 16 as described with respect to the retrieval phase above reconstitutes the initial plain text sensitive data element from the placeholder and returns the initial plain text sensitive data element back to the trusted processing service 19. The trusted processing service 19 receives the plain text sensitive data element from the replacement service 16 and exchanges the placeholder in the non-sensitive instructing message with the plain text sensitive data element to obtain a sensitive instructing message. Afterwards, the trusted processing service 19 processes the sensitive instructing message including the plain text sensitive data element to obtain a sensitive data processing result. This sensitive data processing result contains the information initially requested by the general application service 13. However, it still contains the plain text sensitive data element, which must not be routed back to the general execution area 4.

Thus, the trusted processing service 19 identifies the plain text sensitive data element in the sensitive data processing result, transmits the plain text sensitive data element to the replacement service 16. The replacement service 16 now operates as described above with respect to the securing phase. The replacement service 16 receives the plain text sensitive data element, generates the placeholder from the plain text sensitive data element and sends back the placeholder to the trusted processing service 19. The trusted processing service 19 exchanges the plain text sensitive data element in the sensitive data processing result with the placeholder and thereby generates a non-sensitive data processing result. This non-sensitive data processing result is transmitted back to the general application service 13 which initially request processing.

The trusted execution areas 5 of the system 1 according to FIGS. 1 and 2 although part of the Software as a Service provider's execution environment 3 are isolated such that the sensitive data in the trusted execution area 5 is exclusively accessible by the tenant.

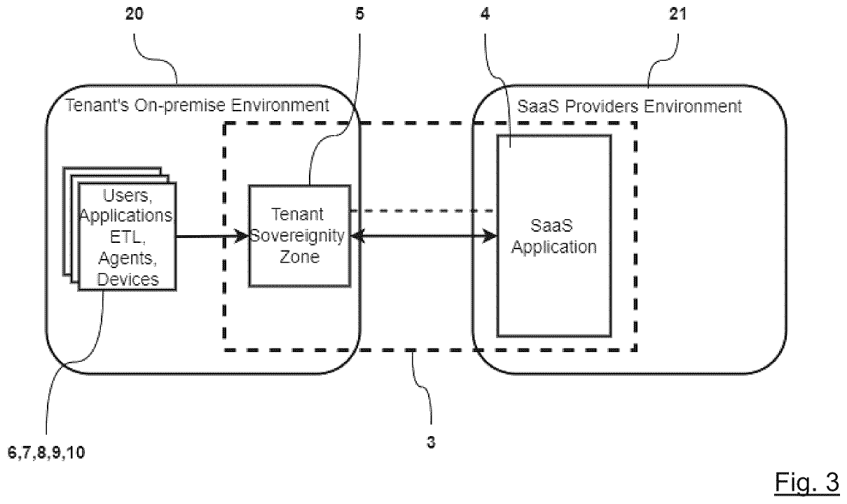

Exclusive access of the sensitive data including at least one plain text sensitive data element can be implemented in different ways. Some schemes for implementation are now described with reference to FIGS. 3 to 5.

In the embodiment of FIG. 3, the trusted execution area 5 is implemented on the tenant's premises 20 while the general application area 4 is implemented on the Software as a Service provider's premises 21. This way, the sensitive data including at least one plain text sensitive data element never leaves the tenant's premises 20. Still, the trusted execution area 5 is part of the Software as a Service provider's execution environment 3 and thus under the Software as a Service provider's management and orchestration O.

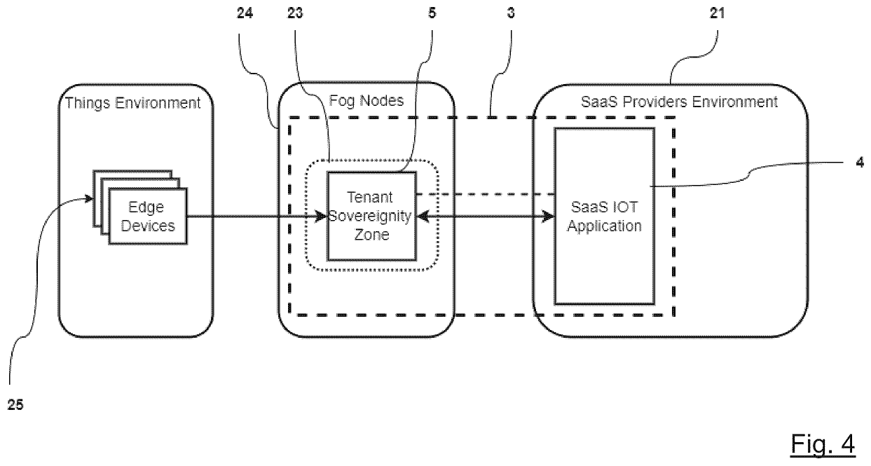

In another embodiment as schematically represented in FIG. 4, the trusted execution area 5 is implemented in a tenant's public cloud environment 22 and in particular in a hardware-based attested trusted execution environment (TEE) 23 in the cloud environment 22.

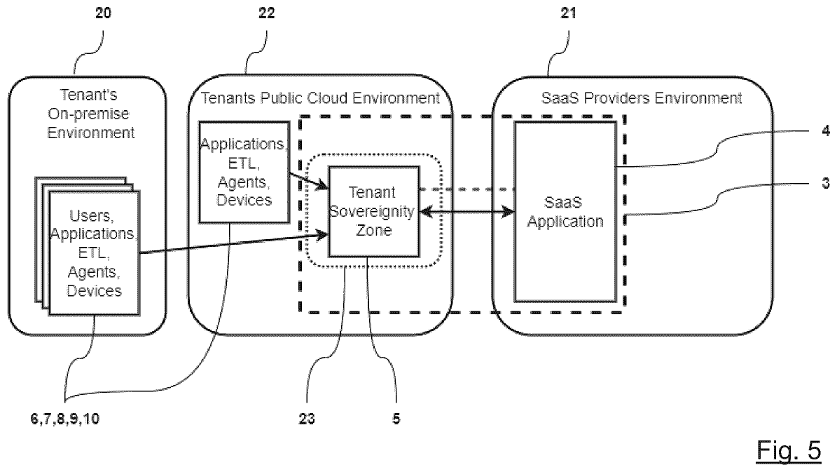

In the implementation exemplary depicted in FIG. 5, the trusted execution area 5 is part of an edge network 24 connected to a plurality of edge devices 25, e.g. IoT devices. The trusted execution area 5 is isolated from the edge network provider by implementing computation in a hardware-based, attested trusted execution environment (TEE) 23.

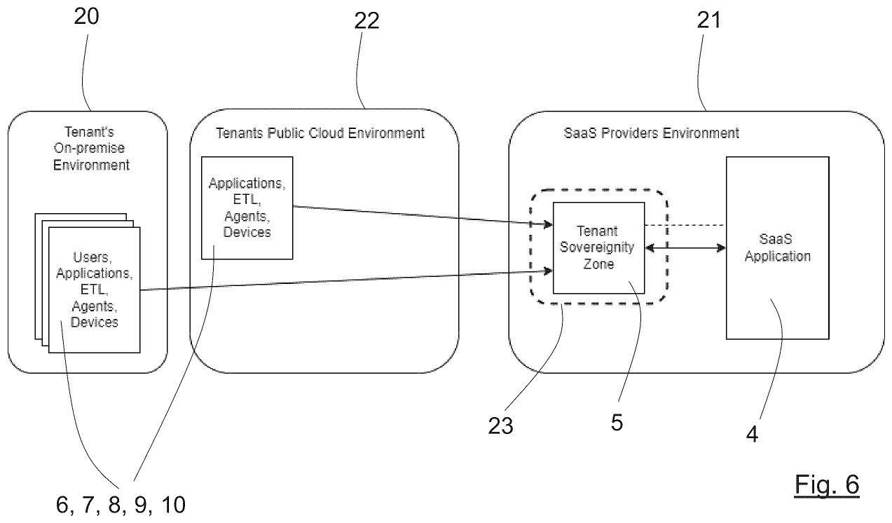

In the implementation illustrated in FIG. 6 the trusted execution area 5 is deployed on the premises 21 of the Software as a Service provider. Optionally the trusted execution area 5 is contained in an attested trusted execution environment 23 within the Software as a Service provider's infrastructure 21.

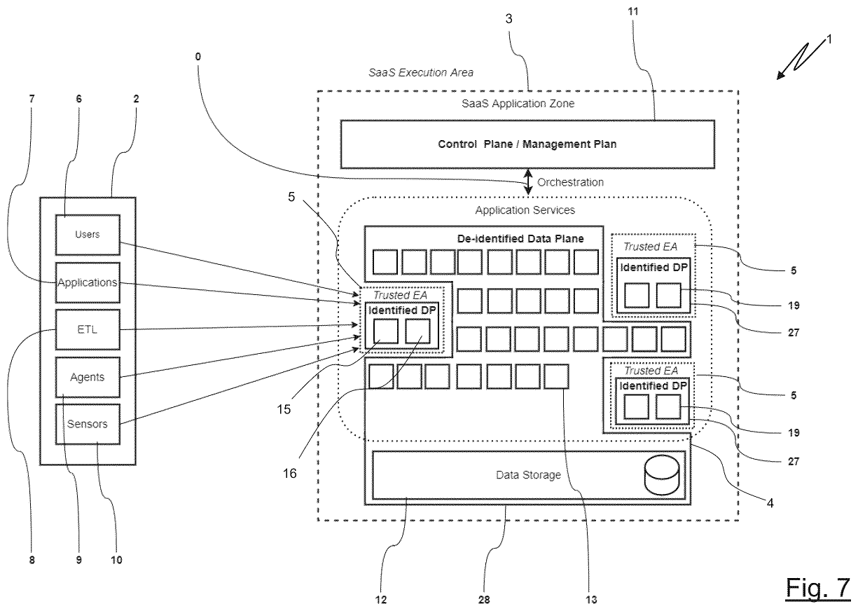

In the system 1 of FIG. 7 the Software as a Service provider's execution environment 3 is still split into a general execution area 4 and a plurality of trusted execution areas 5. The system 1 of FIG. 7 differs from the systems 1 of FIGS. 1 and 2 in that the system 1 comprises a plurality of trusted execution areas 5, which are no longer segregated entities in a data network, but are implemented as enclaves between the Software as a Service provider's general application services 13. Each of the trusted execution areas 5 comprises one or more trusted application services. In the example of FIG. 7, there are two trusted application services 15, 16, 19 running in each trusted execution area 5.

As explained above with respect to FIGS. 1 and 2, the general execution area 4 included in the Software as a Service provider's execution environment 3 provides the typical functionalities of an execution area as known from the prior art. The general execution area 4 has a control or management plane 11 which orchestrates O the general application area 4 including a data storage 12 and a plurality of general application services 13 as well as the trusted execution areas 5 and more specifically the trusted application services operated in the trusted execution areas 5. Although being implemented as enclaves between the general application services 13, the trusted execution areas 5 do not allow any access by any other entity in the general execution area 4 to any of the sensitive data processed in the trusted execution areas 5. The sensitive data processed in the trusted execution area 5 cannot be accessed by any other entity but the tenant data sources 2.

One of the trusted application services is a gateway service 15 and a second trusted application service is a replacement service 16. These two trusted application services 15, 16 of FIG. 7 convert sensitive data including one or a plurality of plain text sensitive data elements into non-sensitive data which can be processed without any restrictions in the general execution area 4 and vice versa. The gateway service 15 of the system of FIG. 1 intercepts all data traffic 17 from the different entities 6, 7, 8, 9, 10 of the tenant data sources 2 into the Software as a Service provider's execution environment 3. Conversion of sensitive data into non-sensitive data, is carried out as described in detail with reference to FIG. 1. In the general execution area 4 the non-sensitive data is processed in one or more of the plurality of the general application services 13.

For the purpose of the original disclosure, it is pointed out that all features as they become apparent to a person skilled in the art from the present description, the drawings and the claims, even if they have been specifically described only in connection with certain further features, can be combined both individually and in any desired combinations with other of the features or groups of features disclosed herein, unless this has been expressly excluded or technical circumstances render such combinations impossible or pointless. A comprehensive explicit description of all conceivable combinations of features is omitted here only for the sake of brevity and readability of the description.

While the invention has been illustrated and described in detail in the drawings and the foregoing description, the illustration and description are merely exemplary and are not intended to limit the scope of protection as defined by the claims. The invention is not limited to the embodiments disclosed.

Variations of the disclosed embodiments will be apparent for those skilled in the art from the drawings, description and appended claims. In the claims, the word “comprising” does not exclude other elements or steps, and the indefinite article “a” does not exclude a plurality. The mere fact that certain features are claimed in different claims does not exclude their combination. Reference signs in the claims are not intended to limit the scope of protection.

### LIST OF REFERENCES

1 system
2 tenant data sources
3 execution environment
4 general execution area
5 trusted execution area
6 users
7 applications
8 ETL processes
9 agents
10 sensors
11 control or management plane
12 data storage
13 general application service
14 sovereignty sphere of the tenant
15 gateway service
16 replacement service
17 data traffic between the tenant and the gateway service
18 secrets
19 trusted processing service
20 premises of the tenant
21 premises of the service provider
22 cloud environment
23 attested trusted execution environment (TEE)
24 edge network
25 edge devices
26 data traffic between the general execution area and the gateway service
27 de-identified data plane
28 identified data plane
O orchestration

1. A system for secure processing and storing of sensitive data and non-sensitive data of a tenant in an execution environment of a Software as a Service provider or of a Platform as a Service provider;
wherein the sensitive data includes a plaintext sensitive data element;
wherein the non-sensitive data includes no plaintext sensitive data element;
wherein the execution environment comprises
a general execution area,
wherein the general execution area allows full access by the Software as
a Service provider or the Platform as a Service provider, and
a general application service running in the general execution area,
wherein the general application service does not have access to the sensitive data, and
wherein the general application service only processes the non-sensitive data; and
wherein the execution environment for the tenant comprises
a trusted execution area, and
a trusted application service running in the trusted execution area.

2. The system according to claim 1, wherein the trusted application service is a gateway service,
wherein the gateway service is configured in such a way that during operation of the system the gateway service
splits the sensitive data and the non-sensitive data,
always routes the sensitive data to the trusted execution area, and
optionally routes the non-sensitive data to the general execution area.

3. The system according to claim 1, wherein the system comprises a plurality of trusted application services, wherein one of the plurality of trusted application service is a replacement service,
wherein the replacement service is configured in such a way that during operation of the system the replacement service carries out the steps
in a securing phase
the replacement service receiving the plaintext sensitive data element from a requesting service originating from the plurality of trusted application services,
the replacement service providing a placeholder for the at least one plaintext sensitive data element in a way allowing later reconstitution of the sensitive data element from the placeholder, and
the replacement service sending the placeholder to the requesting service,
and in a retrieval phase
the replacement service receiving the placeholder from a requesting service originating from the plurality of trusted application services,
the replacement service reconstituting the plaintext sensitive data element associated with the placeholder, and
the replacement service sending the plaintext sensitive data element to
the requesting service.

4. The system according to claim 3, wherein one of the plurality of trusted application services is a gateway service,
wherein the gateway service is configured in such a way that during operation of the system the gateway service carries out the steps
in a securing phase
the gateway service receiving the sensitive data including the plaintext sensitive data element from a tenant data source at the tenant outside the execution environment or from one of the plurality of trusted application services,
the gateway service identifying the plaintext sensitive data element in the sensitive data,
the gateway service transmitting the plaintext sensitive data element to the replacement service,
the gateway service receiving the placeholder from the replacement service,
the gateway service replacing the sensitive data element in the sensitive data with the placeholder to generate the non-sensitive data, and
the gateway service forwarding the non-sensitive data to one of the plurality of general application services,
and in a retrieval phase
the gateway service receiving the non-sensitive data including the placeholder from one of the plurality of general application services,
the gateway service identifying the placeholder in the non-sensitive data,
the gateway service transmitting the placeholder to the replacement service,
the gateway service receiving the plaintext sensitive data element from the replacement service,
the gateway service replacing the placeholder with the plaintext sensitive data element in the non-sensitive data to obtain the sensitive data, and
the gateway service forwarding the sensitive data to a tenant data source at the tenant outside the execution environment or to one of the plurality of trusted application services.

5. The system according to claim 3, wherein a trusted processing service is the requesting service out of the plurality of trusted application services,
wherein the trusted processing service is configured in such a way that during operation of the system the trusted processing service carries out the steps
receiving a non-sensitive instructing message from the general application service,
identifying a placeholder in the non-sensitive instructing message,
transmitting the placeholder to the replacement service,
receiving the plaintext sensitive data element from the replacement service,
replacing the placeholder in the non-sensitive instructing message with the plaintext sensitive data element to obtain a sensitive instructing message,
processing the sensitive instructing message including the plaintext sensitive data element to obtain a sensitive data processing result,
identifying the plaintext sensitive data element in the sensitive data processing result,
transmitting the plaintext sensitive data element to the replacement service,
receiving the placeholder from the replacement service, replacing the plaintext sensitive data element in the sensitive data processing result with the placeholder to generate a non-sensitive data processing result, and
transmitting the non-sensitive data processing result to the general application service.

6. The system according to claim 1, wherein the trusted execution area is isolated such that the sensitive data in the trusted execution area is exclusively accessible by the tenant.

7. The system according to claim 1, wherein the system comprises a control plane for the execution environment enabling at least orchestration of the general application service in the general execution area and of the trusted application service in the trusted execution area.

8. The system according to claim 1, wherein the trusted execution area is implemented on premise or in a private or public cloud infrastructure under control of the tenant.

9. The system according to claim 1, wherein the trusted execution area is isolated such that the sensitive data in the trusted execution area is exclusively accessible by the tenant by implementation of the trusted execution area in a hardware-based, attested trusted environment.

10. The system according to claim 1, wherein the trusted execution area is implemented on an edge network.

11. The system according to claim 10, wherein the trusted execution area is isolated from an edge network provider by performing computation in a hardware-based, attested Trusted Execution Environment.

12. The system according to claim 1, wherein for providing a placeholder for the plaintext sensitive data element the replacement service uses a method of a group consisting of pseudonymization, tokenization, anonymization, and encryption.

13. The system according to claim 1, wherein for providing a placeholder for the plaintext sensitive data element the replacement service uses homomorphic encryption.
